(19) United States
(12) Patent Application Publication
(10) Pub. No.: US 2007/0022148 A1
(43) Pub. Date: Jan. 25, 2007

(54) Reserving an area of a storage medium for a file

(76) Inventors: David G. Akers, Merrimack, NH (US); Timothy W. Mark, Goffstown, NH (US); Devin P. Borland, Alpharetta, GA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/185,052

(22) Filed: Jul. 20, 2005

(51) Int. Cl. G06F 17/30

(52) U.S. Cl. 707/205

(57) ABSTRACT

In response to receiving a first request for storage space for a file, an area of a storage medium is reserved. A data structure is stored in persistent storage to track the reserved area. A second request is subsequently received for storage space for the file. Free space in the reserved area is allocated to the file in response to the second request.

### BACKGROUND

Data can be stored in various types of storage devices, including magnetic storage devices (such as magnetic disk drives), optical storage devices, integrated circuit storage devices, and so forth. Typically, data is stored in files that are managed by a file system. A file system is a mechanism for storing and organizing data to allow software in a computer to easily find and access the data.

Files associated with a file system can become fragmented due to various causes. For example, one of the causes of fragmentation is from requests associated with different files that are received concurrently by a file system. The file system usually allocates space for storage of files on the storage medium on a first come, first served basis. In response to concurrently receiving requests (e.g., write requests) associated with different files where allocation of storage space is involved, sections of a contiguous region of the storage medium are allocated for storing different files. If any of the files has to later grow in size, then the file system will have to allocate a storage region from a different part of the storage medium that is non-contiguous with the first region allocated to the file. Allocation of such disjointed storage regions to a file results in fragmentation of the file.

Fragmentation leads to increased overhead in managing the file, since additional data structures have to be defined to keep track of the disjointed storage regions that contain different parts of the file. Also, accessing a fragmented file is usually associated with increased input/output access time since the storage system has to access different parts of the storage medium to retrieve the file. Increased access time due to fragmentation of a file is especially acute with disk-based storage devices, where seek times for accessing different parts of the disk can be substantial.

Some conventional solutions attempt to access storage regions randomly when performing allocation for files in the hope that concurrent access by several requests associated with different files will not compete for contiguous storage regions. However, conventional random-based allocations of storage regions still suffer from a relatively high likelihood of fragmented files. Other conventional solutions have attempted to define an in-memory reservation for a file that is maintained open. The in-memory reservation causes storage regions to be reserved for a file to reduce likelihood of fragmentation. However, once the file is closed, or if the system resets or reboots, the in-memory data structure is deleted or lost since the data structure is stored in non-persistent memory. In other words, once the file is closed or if the system resets or reboots, all reservation information is lost, and subsequent requests for the file will not benefit from reserved storage regions.

### BRIEF DESCRIPTION OF THE DRAWINGS

FIG. 1 is a block diagram of an exemplary system that incorporates a file system according to an embodiment.

FIG. 2 is a flow diagram of a process performed by the file system for allocating storage regions based on reservations maintained in indexes according to some embodiments of the invention.

FIGS. 3 and 4 illustrate indexes in the form of a reserved space B-tree and free space B-tree, according to some embodiments.

### DETAILED DESCRIPTION

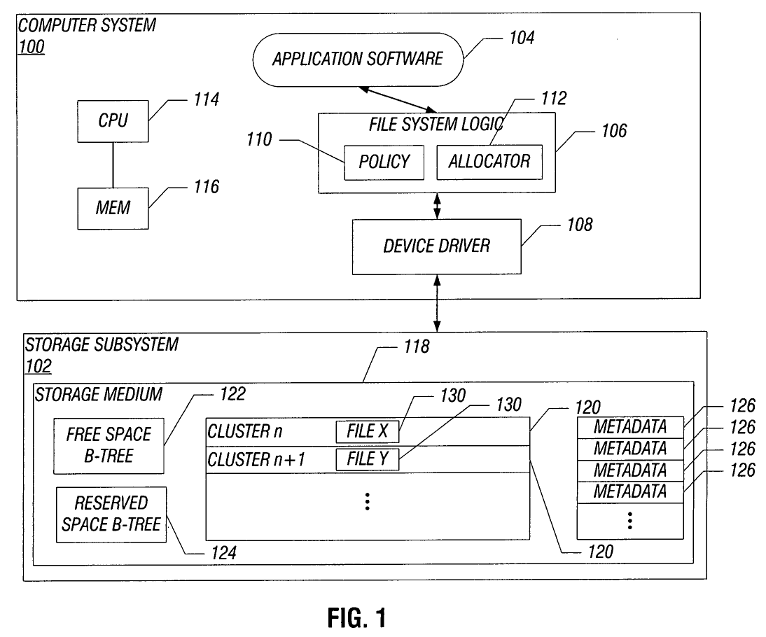

As depicted in FIG. 1, a computer system 100 is coupled to a storage subsystem 102. The storage subsystem 102 includes a storage medium 118 for storing user data in the form of files 130. The storage medium 118 also stores other data, including file system metadata 126, a free space B-tree 122, and a reserved space B-tree 124. The term “user data” broadly refers to data that is associated with either a user, application, or other software in a computer system. Examples of user data include, but are not limited to, user files, software code, and data maintained by applications or other software. “Metadata” is information that describes the stored user data. Examples of metadata include file names, information relating to ownership and access rights, last modified date, file size, and other information relating to the structure, content, and attributes of files containing user data.

Each of the free space B-tree 122 and reserved space B-tree 124 is effectively an index that tracks free storage regions on the storage medium 118. A B-tree is a balanced search tree that has nodes associated with keys. The B-tree 122 or 124 is a relatively fast lookup tree that can quickly be accessed to determine free storage regions according to some embodiments of the invention.

The free space B-tree 122 and reserved space B-tree 124 are used to enable the reservation of contiguous storage regions of the storage medium 118 for respective files to reduce likelihood of fragmentation. In other embodiments, instead of using B-trees 122 and 124 to enable reservation of storage space, other types of indexes or other data structures can be used instead.

The storage subsystem 102 can be implemented with various types of storage devices, including disk-based storage devices, integrated circuit devices, and other types of storage devices. Examples of the storage medium 118 include disk-based storage medium (e.g., magnetic or optical disk or disks), integrated circuit-based storage medium, nanotechnology or microscopy-based storage medium, or other types of storage media. The term “storage medium” refers to either a single storage medium or multiple storage media (e.g., multiple disks, multiple chips, etc.). Although the storage subsystem 102 is illustrated as being separate from the computer system 100, it is contemplated that the storage subsystem 102 can be part of the computer system 100.

In accordance with some embodiments, the free space B-tree 122 and reserved space B-tree 124 are persistent data or information maintained on the storage medium 118, which is implemented with persistent storage device(s). In other implementations, the B-trees 122 and 124 can be stored in a persistent storage separate from the storage medium 118. Persistent data or information refers to data or information that is maintained even if associated files are closed or when the computer system and/or storage subsystem 102 is subject to reboot or reset. A persistent storage is storage that maintains its content even if power is removed from the storage. By maintaining persistent B-trees 122 and 124 (or other forms of indexes or data structures), reservation information of storage space for files can be maintained so that the reservation information is not lost due to closing of files or system reboot/reset. A file is “open” if the file is in a state where at least a portion of a file is retrieved from storage and the content of the retrieved portion is presented to the user for viewing or updating. A file is “closed” if the file is in a state where the file is saved back to storage and the user no longer has access to view or update the file.

The free space B-tree 122 maps free space on the storage medium 118 by storage medium block offset. A “block offset” refers to an address of the start of a “block.” A “block” refers to a predefined amount of storage space. Each leaf node (lowest level node) of the free space B-tree 122 corresponds to a cluster 120 (having a predefined size) of contiguous storage regions on the storage medium 118. A leaf node of the free space B-tree 122 can also correspond to plural clusters. A cluster (which includes plural blocks) has a size that is referred to as a “reservation unit.” In one example, a reservation unit is one MB (megabyte) in size. In other implementations, other reservation units can be defined. Clusters 120 are shown as being part of the storage medium 118 in FIG. 1. Effectively, the free space B-tree 122 is an index that tracks the free clusters (clusters that have not been allocated to store data) on the storage medium 118.

In response to an initial request for a file, the free space B-tree 122 is examined to find a free cluster. This free cluster is reserved for the file, with the reserved cluster information stored in the reserved space B-tree 124. Once a cluster is reserved, information pertaining to that cluster is moved out of the free space B-tree 122 so that the free space B-tree 122 no longer indicates that cluster as being free. Note that a file is often smaller in size than a reservation unit, which means that the reserved cluster contains more storage space to the file than the file needs. Therefore, there will often be free storage regions in the reserved cluster for the file.

The reserved space B-tree 124 keeps track of free storage regions in each reserved cluster for a respective file. Any subsequent request associated with the same file (for which a cluster has been reserved) that requests allocation of storage space can be allocated contiguous storage regions from the reserved cluster. In this manner, as a file grows in size, successive contiguous storage regions from the reserved cluster can be allocated to the file such that the likelihood of fragmentation is reduced. Note, however, that if a file grows to a size that exceeds a cluster size, then multiple clusters have to be defined for storing the file. Mechanisms according to some embodiments attempt to find contiguous clusters to store a file that exceeds a cluster size. The free space B-tree 122 will be searched for the block offset of the next contiguous cluster.

As depicted in FIG. 1, a file “X” is stored in cluster n, while a file “Y” is stored in cluster n+1. The reserved space B-tree 124 indicates that cluster n has been reserved for file “X,” while cluster n+1 has been reserved for file “Y.” Any free clusters 120 in the storage medium 118 are maintained in the free space B-tree 122.

The computer system 100 includes file system logic 106 that accesses data stored in the storage subsystem 102 through a device driver 108. The file system logic 106 receives requests (read or write requests) from application software 104 or other software. In response to these requests, the file system logic 106 issues file system requests (read requests or write requests) to the storage subsystem 102 through the device driver 108 for reading or writing data in the storage subsystem 102.

The file system logic 106 and file system metadata 126 are part of a file system. A file system is basically an entity that contains methods and routines, as well as data structures in the form of file system metadata, to organize user data (contained in the files 130) and to manage access of such user data. The files 130 themselves can also be considered to be part of the file system. Moreover, the free space B-tree and reserved space B-tree according to some embodiments of the invention can also be considered to be part of the file system.

The computer system 100 also includes a central processing unit (CPU) 114 (or multiple CPUs) that is (are) coupled to a memory 116. According to one embodiment, the memory 116 is implemented with non-persistent storage device(s), such as dynamic random access memory (DRAM), a synchronous DRAM (SDRAM), a static random access memory (SRAM), and so forth.

The file system logic 106 includes a storage allocator 112 for allocating storage space on the storage medium 118 to files. The storage allocator 112 is also responsible for maintaining the B-trees 122 and 124. The file system logic 106 also includes a policy block 110 for maintaining the storage policy (or storage policies) for files or applications. In some embodiments, various policies can be specified, with one of these policies being a soft reservation policy in which a cluster is reserved for a file in response to an initial request to allocate space for the file. Note that such reservation is referred to as a “soft reservation” because the free regions of the reserved cluster can be allocated to a different file should the storage medium 118 run out of free clusters. Another policy that can be specified by the policy module 110 is a static allocation policy in which a reservation is not given to particular files, such as files that are not expected to grow in size. Other types of policies can also be specified by the policy module 110.

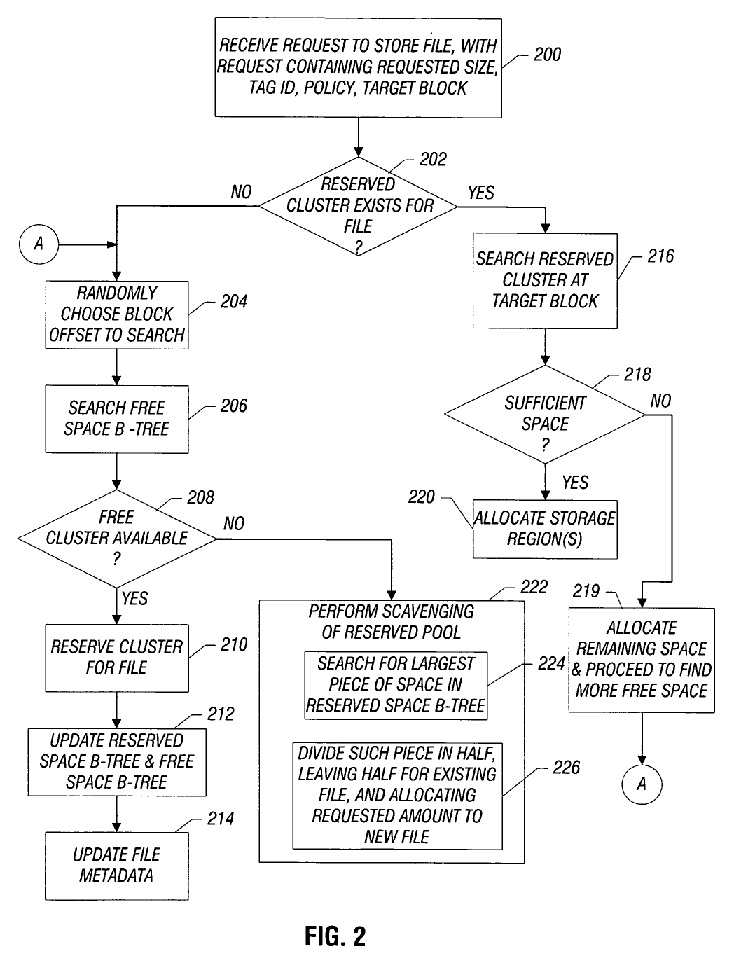

Reference is made to FIGS. 1 and 2 in the following description. FIG. 2 is a flow diagram of a process according to an exemplary embodiment. The storage allocator 112 receives (at 200) a request from the file system logic 106. The request received from the file system logic 106 is generated in response to a request from application software 104 or from another source. The request received by the storage allocator 112 contains the requested size for the file, the tag of the file (which is also the file identifier), the policy for allocation of storage, and a target block. In some embodiments, various policies can be specified by the policy module 110 as discussed above.

The target block included in the request indicates to the storage allocator 112 that the caller has indicated that storage of the file at this starting target block will produce an optimal storage layout for the file. The tag identifier identifies the file and is used by the storage allocator 112 to determine whether a reserved space has been provided for the file. The requested size allows the storage allocator 112 to know how much storage space to allocate.

In response to the request, the storage allocator 112 determines (at 202) if a reserved cluster exists for the file. This determination is accomplished by searching the reserved space B-tree 124 to find if a cluster has already been reserved for the file. The tag identifier included in the request is compared by the storage allocator 112 to information associated with leaf nodes of the reserved space B-tree 124 to determine if a match is present. The information associated with each leaf node of the reserved space B-tree 124 contains file identifier information for the file(s) associated with the reserved cluster represented by the leaf node. A match between the file identifier in the received request and a file identifier in a leaf node of the reserved space B-tree 124 indicates that a cluster has been reserved for the file associated with the received request.

In response to determining that a reserved cluster exists for the file, a search of the reserved cluster is performed (at 216), starting at the target block. The target block can be used as an index into the reserved space B-tree 124 to allocate space starting at the desired target block. The storage allocator 112 determines (at 218) if sufficient available space exists in the reserved cluster for the requested size specified in the request. If so, then the storage allocator 112 allocates (at 220) storage region(s) according to the requested size.

However, if insufficient space is present as determined at 218, then the storage allocator 112 allocates (at 219) the remaining space in the reserved cluster to the file, and proceeds to task 204 to obtaining additional storage space for the remainder of the requested space. The process also proceeds to task 204 in response to determining (at 202) that a reserved cluster does not exist for the file associated with the received request. In task 204, the storage allocator 112 randomly chooses (at 204) a block offset to search. The block offset chosen is the address of the start of a reservation unit. Randomly choosing a block offset to search reduces the likelihood that consecutive clusters are given out sequentially to concurrently received requests for different files. Not allocating clusters sequentially to concurrently received requests for different files increases the likelihood that a neighboring cluster that is contiguous with a reserved cluster for a particular file will remain free such that if the particular file increases in size to greater than the size of a cluster, the neighboring cluster will more likely be available for allocation to the particular file. Allocating contiguous clusters to a file avoids fragmentation of the file. Note that the computer system 100 provides a multi-threaded environment in which multiple threads or processes can be concurrently active to issue concurrent requests to the file system logic 106.

Based on the randomly chosen block offset, the free space B-tree is searched (at 206). The storage allocator 112 determines (at 208) whether a free cluster is available. If so, then the free cluster is reserved (at 210) for the file. The reserved space B-tree 124 and the free space B-tree 122 are updated (at 212) to perform this reservation. As a cluster is reserved, the free space B-tree 122 is updated to indicate that the cluster is no longer free. Information pertaining to the reserved cluster is moved into the reserved space B-tree 124, which keeps information relating to free storage regions of the reserved cluster for the file. The storage allocator 112 also updates (at 214) the file system metadata 126 to indicate the cluster reservation for the file.

If the storage allocator 112 determines (at 208) that no free cluster is available on the storage medium 118 (in other words, all clusters have been reserved for files), then the storage allocator 112 performs (at 222) scavenging of the reserved pool (the pool of reserved clusters identified by the reserved space B-tree 124). Scavenging refers to “stealing” storage regions from a cluster that is reserved for another file. The storage allocator 112 searches (at 224) the leaf node of the reserved space B-tree 124 that the allocator last looked at for the largest piece of space that is available for that leaf node. When such a largest piece is located, the storage allocator 112 divides (at 226) this piece in half, leaving half of the reserved cluster as reserved space for the existing file, and allocating the requested space to the new file associated with the request. The new file is the file associated with the request received at 200. The existing file is the file for which the cluster has been reserved in the reserved space B-tree previously. The remainder (if any) of the allocated space for the new file is then left in the reserved space B-tree 124 as the reservation for the new file in case any more storage requests for the new file are received.

The flow diagram of FIG. 2 is exemplary, where the acts/blocks of the figure can be added, removed, altered, and so forth, and still be covered by embodiments of the invention.

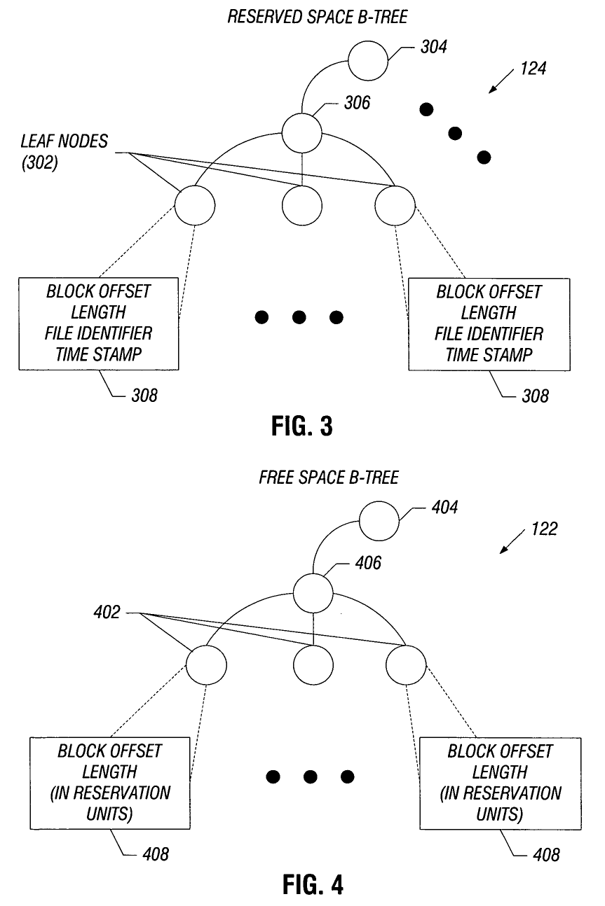

FIGS. 3 and 4 illustrate structures of the reserved space B-tree 124 (FIG. 3) and the free space B-tree 122 (FIG. 4), according to one exemplary embodiment. Note that in other embodiments, other types of data structures can be employed for tracking free clusters on the storage medium 118 (FIG. 1) and free storage regions in reserved clusters. The reserved space B-tree 124 includes a root node 304, intermediate nodes 306, and leaf nodes 302. Note that the B-tree can have greater than a depth of three. The root node and intermediate nodes contain search keys (in the form of block offsets) that are used by the storage allocator 112 to find desired leaf nodes. After the cluster has been reserved for a file, the file takes up a portion of the cluster, which means that some storage regions of the cluster remain free for subsequent use. The leaf nodes 302 identify free storage regions of reserved clusters. A leaf node 302 can have multiple entries that map to multiple free storage regions. Thus, for example, if two storage regions remain available for a cluster reserved for a particular file, then a leaf node 302 would have two entries mapped to the two available storage regions.

Each leaf node 302 is associated with information 308 that includes the block offset (the starting address of a free storage region in a particular cluster). The information 308 also includes a length field to indicate the length of the available storage region. The information 308 also contains a file identifier and a time stamp. The file identifier identifies the file for which the cluster has been reserved. Also, a time stamp is included as part of the information 308 to indicate the time at which the reservation was made. The time stamp can be used by the storage allocator 112 when performing scavenging (222 in FIG. 2). For example, the storage allocator 112 can decide to scavenge from the oldest reservation that is able to satisfy a currently received request.

The free space B-tree 122 similarly includes a root node 404, intermediate nodes 406, and leaf nodes 402. Each leaf node 402 is associated with information 408 containing a starting block offset and a length (in reservation units). Note that a leaf node can specify available space in chunks of one reservation unit (cluster) or multiple reservation units (two or more clusters).

Instructions of software routines (including the file system logic 106, storage allocator 112, policy module 110, application software 104, and device driver 108 in FIG. 1) are loaded for execution on a processor (e.g., CPU 114). The processor includes microprocessors, microcontrollers, processor modules or subsystems (including one or more microprocessors or microcontrollers), or other control or computing devices.

Data and instructions (of the software) are stored in respective storage devices, which are implemented as one or more machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method of software execution, comprising:
receiving a first request for storage space for a file;
reserving an area of a storage medium for the file in response to the first request;
storing a data structure in persistent storage to track the reserved area;
subsequently receiving a second request for storage space for the file; and
allocating free space in the reserved area to the file in response to the second request.

2. The method of claim 1, wherein storing the data structure in the persistent storage comprises storing the data structure on the storage medium.

3. The method of claim 1, further comprising storing a first B-tree to represent free storage space on the storage medium, wherein reserving the area of the storage medium comprises examining the first B-tree to determine that the area is free prior to reserving the area.

4. The method of claim 3, wherein the first B-tree comprises plural leaf nodes, each leaf node representing one or more free clusters on the storage medium, and wherein reserving the area comprises reserving one of the free clusters indicated by leaf nodes of the first B-tree.

5. The method of claim 3, wherein storing the data structure comprises storing a second B-tree to represent free storage space within respective reserved areas of the storage medium, the reserved areas for respective files.

6. The method of claim 5, wherein allocating the free space in the reserved area in response to the second request is based on information associated with the second B-tree.

7. The method of claim 5, wherein the first B-tree contains information to identify areas of the storage medium that are free, wherein the file associated with the first request comprises a first file, the method further comprising:
receiving a request for storage space for a second file;
in response to the request for storage space for the second file, determining, based on examining the first B-tree, that no free areas exist;
in response to determining that no free areas exist on the storage medium, allocating storage space from the reserved area, reserved for the first file, to the second file.

8. The method of claim 5, wherein the first B-tree comprises plural leaf nodes, each leaf node of the first B-tree representing at least a free cluster on the storage medium, and wherein reserving the area comprises reserving one of the free clusters indicated by leaf nodes of the first B-tree, and
wherein the second B-tree has leaf nodes that represent available storage regions in respective reserved areas, the method further comprising:
storing information associated with the leaf nodes of the second B-tree, the stored information containing an identifier of the file that a corresponding one of the reserved areas is associated with.

9. The method of claim 1, further comprising:
subsequently receiving a third request for storage space for the file;
determining if insufficient free space exists in the reserved area for the third request; and
reserving a second area of the storage medium for the file in response to the third request if insufficient free space exists.

10. The method of claim 1, wherein the data structure comprises a first data structure to track the reserved area, the method further comprising:
storing a second data structure in the persistent storage to track free space on the storage medium,
wherein reserving the area of the storage medium for the file in response to the first request comprises updating the first and second data structures.

11. An article comprising at least one storage medium containing instructions that when executed cause a system to:
store persistent data that tracks free clusters on a storage medium;
receive a request to allocate storage space on the storage medium for a first file;
in response to the received request, access the persistent data to find a free cluster for the first file; and
reserve the free cluster for the first file, wherein the reserved cluster is larger in size than the first file.

12. The article of claim 11, wherein the instructions when executed cause the system to further:
receive a second request to allocate additional storage space on the storage medium for the first file; and
in response to the second request, allocate the additional storage space from the reserved cluster to avoid fragmentation of the first file.

13. The article of claim 11, wherein the instructions when executed cause the system to further:
store second persistent data that tracks free storage regions in the reserved cluster for the first file.

14. The article of claim 13, wherein the second persistent data also tracks free storage regions in additional reserved clusters for other files, wherein the instructions when executed cause the system to further:
receive a second request for allocation of storage space on the storage medium for a second file; and
in response to the second request, allocate the storage space for the second file from a reserved cluster for the second file identified by the second persistent data to avoid fragmentation of the second file.

15. The article of claim 14, wherein storing the persistent data that tracks free clusters on the storage medium and storing the second persistent data that tracks free storage regions in the reserved cluster for the first file comprises storing first and second B-trees.

16. The article of claim 11, wherein the instructions when executed cause the system to further:
receive a second request to allocate additional storage space on the storage medium for the first file;
in response to detecting that the reserved cluster does not contain sufficient free space for the additional storage space specified in the second request, reserve another free cluster for the first file based on accessing the persistent data.

17. The article of claim 16, wherein the instructions when executed cause the system to further:
in response to detecting that the reserved cluster contains sufficient free space for the additional storage space specified in the second request, allocate the additional storage space from the reserved cluster.

18. A system comprising:
a persistent storage to store a first data structure that tracks free clusters on a storage medium; and
a storage allocator to:
in response to a first request for allocation of storage space for a first file, examine the first data structure and reserve a free cluster identified by the first data structure for the first file; and
in response to a second request for allocation of additional storage space for the first file, allocate the additional storage space from the reserved cluster.

19. The system of claim 18, wherein the storage allocator receives a third request for allocation of further storage space for the first file, and wherein if the storage allocator determines that insufficient space exists in the reserved cluster for the further storage space specified by the third request, the storage allocator reserves another free cluster identified by the first data structure for the first file.

20. The system of claim 18, wherein the persistent storage further stores a second data structure to track free storage regions in the reserved cluster, and wherein the storage allocator allocates, in response to the second request, one or more free storage regions in the reserved cluster identified by the second data structure.

21. The system of claim 20, wherein the first and second data structures comprise respective first and second B-trees.

22. The system of claim 18, the storage allocator to further:
receive a third request for allocation of storage space for a second file;
in response to the third request, determine that the first data structure indicates that no free clusters are available; and
in response to determining that no free clusters are available, allocate the storage space for the second file from the reserved cluster for the first file.

23. A computer system comprising:
a persistent storage to store a first B-tree to track free clusters on a storage medium, and a second B-tree to track free storage regions in reserved clusters on the storage medium, the reserved clusters being reserved for respective files;
a processor; and
a storage allocator executable on the processor to:
receive a first request to allocate storage space for a first file;
examine the first B-tree to find a free first cluster;
reserve the free first cluster for the first file, wherein the reserved first cluster is larger in size than the first file;
receive a second request to allocate additional storage space for the first file;
allocate one or more free storage regions identified by the second B-tree from the reserved first cluster for the additional storage space specified by the second request;
receive a third request to allocate storage space for a second file;
examine the first B-tree to find a free second cluster; and
reserve the free second cluster for the second file.

24. The system of claim 23, wherein the persistent storage is part of the storage medium.
